(19) United States
(12) Patent Application Publication
(10) Pub. No.: US 2004/0001078 A1
(43) Pub. Date: Jan. 1, 2004

(54) DVD scoring system

(75) Inventors: Michael Eugene Rosing, Batavia, OH (US); James Phillip Smith, Amelia, OH (US)

Correspondence Address: WOOD, HERRON & EVANS, LLP, 2700 CAREW TOWER, 441 VINE STREET, CINCINNATI, OH, 45202, US

(73) Assignee: Sportsman's Market, Inc., Batavia, OH

(21) Appl. No.: 10/185,197

(22) Filed: Jun. 28, 2002

(51) Int. Cl. G09G 5/00

(52) U.S. Cl. 345/700

(57) ABSTRACT

A method, apparatus and program product present DVD displays that are substantially the same in appearance, but include distinct, underlying programming. The displays, in one respect, enable flexible scoring schemes within a DVD environment. One such application allows a user's examination score to remain unaffected by subsequent responses to a missed question.

### FIELD OF THE INVENTION

The present invention relates generally to audio and video playback devices, and more particularly, to DVD programming and associated systems.

### BACKGROUND OF THE INVENTION

Digital Video Discs (DVD) are increasing in popularity due to their fidelity and immense capacity to store information. Entire movies, huge music collections and computer games, for example, can be stored on a single DVD disc. Such information is contained within different storage areas, or domains, of a disc that is read by a DVD player. As explained in more detail below, DVD programming, or pre-mastering, utilizes a highly structured set of rules and commands. These commands are very basic and extremely limited when compared to programming options available in conventional computer systems. For instance, the drag-and-click program user interface of DVD systems provides a programmer with a palette of only six basic commands.

For purposes of this disclosure and as discussed in greater detail below, the commands most notably include: LINK, JUMP, SET SYSTEM and SET commands. LINK commands allow a DVD player to access different areas of a DVD disc within the same domain, while a JUMP command permits navigation to information stored in different domains. SET SYSTEM commands allow users to enter data into available memory, and SET commands enable that data to be mathematically manipulated. Available memory includes a handful of highly structured general parameters (GPRM's). GPRM's typically record the operating history of a user within a DVD session. Thus, within the relatively limited confines of these prescribed features, DVD programming must generally accommodate all sequencing, editing and navigating operations of a DVD presentation.

To this end, DVD pre-mastering involves inserting and assigning commands within programmatic templates comprising DVD building blocks. These templates are typically referred to within the DVD industry as program chains, or PGC's. A typical PGC contains cells having audio and/or video content contained between pre- and post-commands. Pre-commands automatically and sequentially execute prior to playback of the cell content. Post-commands are configured to execute sequentially at the completion of the cell playback. Where desired, buttons may occupy programmably-designated spots on a cell display. Users conventionally highlight and select such buttons using their remote control. Selection of a button, in turn, initiates a command.

Significantly, each button of a cell display executes only a single command. While generally adequate for the movie applications that DVD was originally intended for, such a programmatic limitation can severely constrain DVD applications in other contexts. For instance, certain training and gaming scenarios that would otherwise benefit from DVD features require multifunction tasks that remain unsupported by the one command per button rule of DVD program architecture.

Therefore, there exists a need for an improved manner of premastering and utilizing DVD systems.

### SUMMARY OF THE INVENTION

The present invention provides an improved apparatus, method and program product for presenting and utilizing DVD data in a manner that addresses the shortcomings of the prior art applications. In one respect, an embodiment of the present invention appears to increase the number of commands/effects available to a user for a given display. That is, an embodiment imparts to a viewer an impression that the same button of a DVD display performs different functions. For instance, it may appear to a user that the function of a button varies progressively over the course of an interactive DVD session. To this end, a DVD program may include multiple displays having identical or substantially the same audio and video content. While the displays may be identical in appearance, however, they may contain disparate underlying programming. For instance, a button of a first display that looks the same as another button of a second, apparently identical display may initiate a different command and associated effect. Thus, use of consecutive, indiscernible displays appears to increase the number of commands/effects available to viewers using their remote control interface for a given display.

As such, users selecting what they believe to be the same button of a display may be actually selecting a second button of an entirely different display. Significantly, the second button may include a new command, creating the illusion that a single button/display can interactively accommodate different game/exam features. The visually indiscernible displays, in this regard, can circumvent the programmatic precept of conventional DVD applications that limit each button of a display to a single command. This feature can broaden the number and type of applications compatible with DVD players, while liberating DVD programmers from programming limitations that have conventionally precluded certain program effects.

One such application is directed to scoring an examination administered via a DVD player. More specifically, an embodiment of the present invention accommodates a DVD application that allows a user to re-attempt an inappropriate response to a question or other task without affecting an overall score. For instance, a user answering a series of exam questions on a DVD player in accordance with the principles of the present invention may accrue a point for every missed question. The point may contribute towards an overall score useful in evaluating the performance of the user. However, the overall score remains unaffected by subsequent incorrect or correct answer attempts to the same question. The DVD player may ultimately output the score to the user by correlating it to an appropriate display screen. In similar fashion, a broad number of other scoring and/or video game scenarios may be realized in accordance with the principles of the present invention.

By virtue of the foregoing there is provided an improved premastering mechanism that addresses shortcomings of conventional DVD systems. These and other objects and advantages of the present invention shall be made apparent in the accompanying drawings and the description thereof.

### BRIEF DESCRIPTION OF THE DRAWING

The accompanying drawings, which are incorporated in and constitute a part of this specification, illustrate an embodiment of the invention and, together with a general description of the invention given above, and the detailed description of the embodiment given below, serve to explain the principles of the invention.

FIG. 1 is a block diagram of an audio and visual processing system in accordance with principles of the present invention;

FIG. 2 is a block diagram of a DVD player suited for implementation within the audio and visual processing system of FIG. 1;

FIG. 3 is a diagram representative of the logical structure of a program chain suited for processing within the environments of FIGS. 1 and 2;

FIG. 4 is a display of a question in accordance with the principles of the present invention;

FIG. 5 is an exemplary command layout window annotated with associated content and command fields;

FIG. 6 is logical structure for a design layout in accordance with the principles of the present invention;

FIG. 7 is a menu display suited for presentation to a user within the logical structure of FIG. 6;

FIG. 8 is flowchart outlining method steps suited for execution within the hardware systems of FIGS. 1 and 2;

FIG. 9 is a conceptual diagram of a cell display in accordance with principles of the present invention;

FIG. 10 is another conceptual diagram of a cell display in accordance with principles of the present invention;

FIG. 11 is another conceptual diagram of a cell display in accordance with principles of the present invention;

FIG. 12 is flowchart outlining method steps suited for execution within the hardware systems of FIGS. 1 and 2;

FIG. 13 is another conceptual diagram of a cell display in accordance with principles of the present invention; and

FIG. 14 shows a cell display of illustrative material in accordance with principles of the present invention.

### DETAILED DESCRIPTION OF DRAWINGS

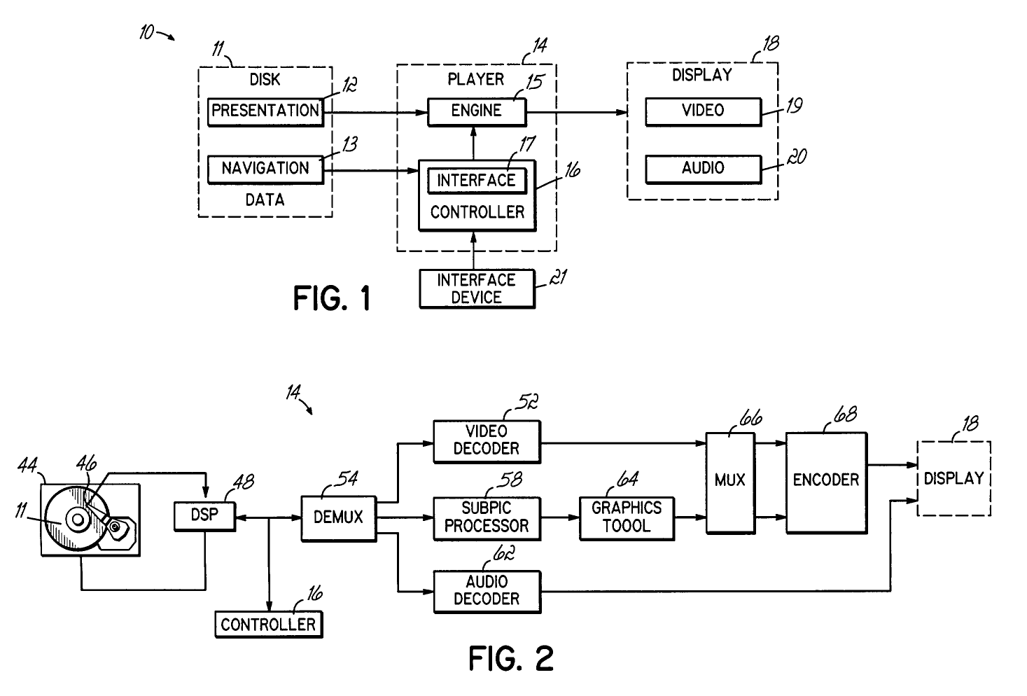

Referring now to the figures, FIG. 1 shows a block diagram of an audio and video processing system 10 in accordance with principles of the present invention. In one respect, the system 10 includes hardware and software suited to present to a user two visually and audibly imperceptible displays having different program content. Generally, FIG. 1 illustrates the basic relationship between presentation data 12 and navigation data 13 in the system 10 that comprises a disc player 14 and a DVD formatted disc 11. Presentation data 12 generally represents the stored audio 20 and video 19 data to be presented at a display 18, while navigation data 13 generally represents pointers and mapping instructions regarding how the presentation data 12 should be played back. The disc player 14 typically reads the presentation and navigation data 12, 13 contents of the disc 11 and initiates presentation on display 18 in accordance with commands from a user interface device 21. Of note, a suitable interface device 21 configured to communicate with the disc player 14 includes a standard DVD remote control. Buttons and associated functionality on a remote control include: PLAY, STOP, PAUSE, NEXT PROGRAM, PREVIOUS PROGRAM, TITLE MENU, ROOT MENU, UP, DOWN, LEFT, RIGHT, ENTER and RETURN. Additionally, remote controls include a numeric keypad for number entry.

FIG. 2 shows a block diagram having basic components of an exemplary video disc player 14 that may be suited for use in the audio and video processing system 10 of FIG. 1, as well as for implementing the novel navigation features of the present invention. Of note, the specific construction and operation of these components are known to one of ordinary skill in the art and will not be discussed in detail herein. Generally referring to FIG. 2, a DVD player 14 operatively accesses and receives information stored upon a DVD disc 11. As discussed herein, such information as is stored on the DVD disc 11 may comprise any combination of video, audio or other data. A spindle motor 44 imparts rotational forces to the DVD disc 11. A laser device 46 positioned approximate to the rotating DVD disc 11 reads information from storage containing surfaces of the disc 11.

Information read by the laser device 46 is provided to a DVD-compliant digital signal processor (DSP) 48. The DSP 48 generates electrical signals representative of the information read from the DVD disc 11 by the laser device 46. Of note, the DSP 48 typically performs functions such as demodulation, error correction and de-scrambling of the raw data read from the disc 11 to format the data suitably for decoder units 52, 62.

The DSP 48 couples to the digital audio and video decoders 62 and 52, respectively. The decoders 52, 62, in turn, process the electrical signals provided by the DSP 48. To this end, the path from the, DSP 48 to the decoder units 52, 62 includes a demultiplexer 54, which is operable to generate a video content stream. The video content stream may be applied to a (MPEG-2) video decoder 52. The demultiplexer 54 may also provide compressed bit maps to a sub-picture processor 58, as well as an audio content stream to an audio (Dolby AC3) decoder 62. The sub-picture processor 58 further generates processed information that may be applied to an on-screen display graphics tool 64, such as an overlain image.

A video multiplexer 66 couples to both the video decoder 52 and the graphics tool 64. The multiplexer 66 controllably presents decoded video information generated from the video decoder 52 and output signals generated by the graphics tool 64 to an appropriate TV signal encoder 68. An exemplary signal encoder 68 includes a NTSC-PAL. The encoder 68, in turn, provides a suitable TV signal for application to a television 18 for playback. Similarly, decoded audio information generated by the audio decoder 62 is provided to an appropriate audio system. In one embodiment, the audio system may be integrated with the TV display 18.

A controller 16 may be also comprise a portion of the DVD player 14. As such, the controller 16 may couple to both the DSP 48 and the demultiplexer 54. The controller 16 may supervise and control operation of the DSP. As discussed in the text describing FIG. 1, a suitable controller 62 may be engaged by a user by way of remote control 21, or keys forming a portion of a front housing panel of the DVD player 14. User input received via the remote control 21 or key pad thus translates into commands controlling operation of the controller 16 and, subsequently, operation of the drive elements of the DVD player 14.

One skilled in premastering techniques should appreciate that the DVD player may include an interface (not shown) with one or more networks (e.g., a LAN, a WAN, a wireless network, and/or the Internet, among others) to permit the communication of information with other DVD players or computers coupled to the network. Thus, various applications, components, programs, objects, modules, etc. may also execute on one or more processors in another controller coupled to the DVD player via a network.

In general, the routines executed to implement the embodiments of the invention, whether implemented as part of normal DVD program execution or a specific application, component, program, object, module or sequence of instructions will be referred to herein as “commands,” “programs” or “program code.” Furthermore, command/program code may be interpreted as comprising multiple, distinct functions or algorithms used throughout an entire DVD program sequence or operation. The commands typically comprise one or more instructions that are resident at various times in various memory and storage devices. When a command is read and executed by the controller 16 or other processor, the command causes the DVD player 14 to execute steps or elements embodying the various aspects of the invention.

Furthermore, while the invention has and hereinafter will be described in the context of fully functioning DVD players and supporting systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include, but are not limited to recordable type media such as volatile and non-volatile memory devices, floppy and other removable discs 11, hard disc drives, opticals (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature. Moreover, those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

Of note, the DVD disc 11 and associated player 14 of FIG. 2 utilize program chains (PGC 's) to store, manipulate and transfer pertinent data and instructions. As discussed herein, PGC's include programmatic templates used to convey content and direct navigation of data stored on a DVD disc 11. In one regard, PGC's instruct the DVD player on how multiplexed audio, video and sub-picture overlays should be played back, as well as under what conditions and in what order they should play.

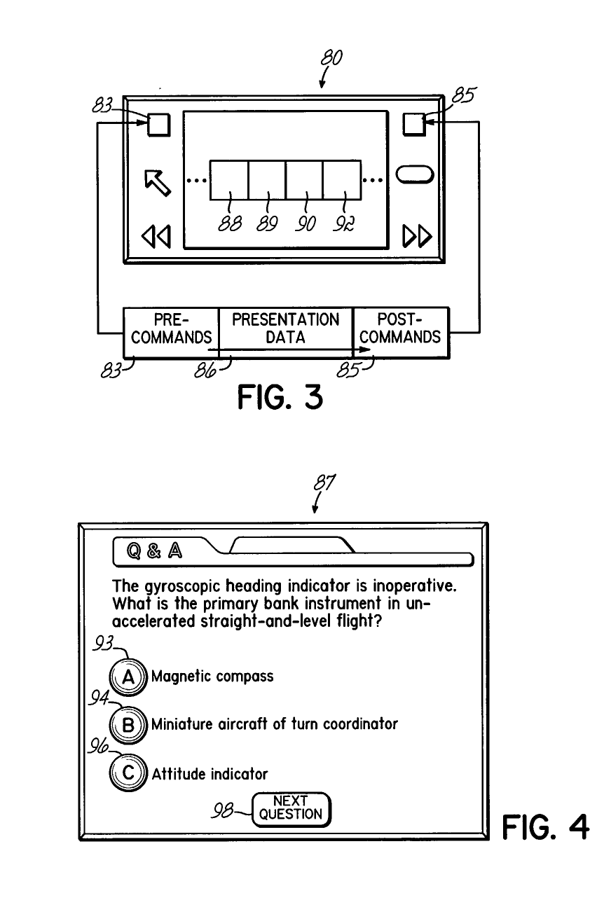

FIG. 3 shows a logical structure/layout window representative of an exemplary PGC 80. The PGC 80 includes a group of commands contained in pre-command and post-command areas 83 and 85, respectively. Pre-commands 83 issue before the presentation of audio and video data 86 within a PGC 80. This pre-command area 83 can hold up to 128 commands. Post-commands 85 issue after the presentation of material within a PGC 80. The post-command area 85 can also hold up to 128 commands. A pre-command 83 sets the condition for the data 86 to follow, such as which audio stream will be played, or whether a program has been recently viewed. This is followed by a list of cells 88-92 within the presentation data 86 to be played back. Pre-commands 83 and post-commands 85 are typically used to control the flow of play, memorize a viewer's actions and control the DVD player 14. When a PGC 80 is played, all of the commands in the pre-command area 83 are processed. If these commands 82 do not navigate playback out of the PGC 80, the first designated cell 88 is played. After the cells 88-92 are played through, the commands in the post-command area 85 typically process. For example, where a disc 11 comprises multiple videos, a command in a post-command area 85 may execute to either stop and display a menu, or play through to another video contained in another PGC.

Such pre- and post-commands 83, 85 have particular application in navigating throughout stored DVD data 86 according to preset program protocol. That is, a DVD designer will use pre/post-commands 83, 85 to stipulate the order, exposure and other display parameters of certain, non-interactive aspects of a DVD program. Such commands commonly link PGC's in order to construct a playback sequence as prescribed by a DVD designer.

Other features of the interactive drag-and-click programming interface of a DVD system 10 enable input of navigational commands received directly from a user. To this end, programmatically designated spots, or buttons, on a display configured to receive input may be included within the program architecture of each cell 88-92 of a PGC 80. Thus, buttons may function as remote-control 21 accessible spots through which a viewer can select a playback option. Notably, the option may correlate to a navigational command executable by the DVD player 14. As discussed herein, such commands may include LINK, JUMP, SET SYSTEM and SET commands. For purposes of this disclosure, LINK commands include any function configured to allow navigation to different cells of the same PGC, while JUMP commands include those configured to programmatically connect to cells in different PGC's. SET SYSTEM commands allow users to initiate entry of data into available memory, and SET commands enable manipulation of that and/or other memory. Of note, both SET and SET SYSTEM command comprise composite commands, allowing them to LINK to other cells within the same PGC after performing their primary command function.

A button area command may thus be inserted into a display of a cell 88 and be activated by the user via the remote control 21. Significantly, only one command is permitted per button. As discussed above, this limitation may severely restrict certain DVD applications where it would be desirable for a single button to perform multiple functions. For example, such a feature may be useful in the context of scoring, where it may be desirable for input to a button from a user to initiate both incrementing of a score and navigating to another cell display.

An exemplary cell display 87 having four buttons 93-98 in accordance with the principles of the present invention is shown in FIG. 4. Of note, a programmer may adjust the size, color, highlight sequence and orientation of buttons 93-98 according to aesthetic or functional preference. Moreover, while the display 87 of FIG. 4 may have application in an examination context, and particularly, a test administered for flight instruction purposes, one skilled in the art should appreciate that other suitable displays could accommodate arcade-type games and other amusements. To this end, a suitable display could include streaming video and/or audio. Each button 93-98 shown in FIG. 4 may be configured to initiate a single command. The command may be different or the same as that associated with other buttons. To this end, each button 93-98 may correlate to a button command editor window. The button command editor window provides, in one respect, a programmable interface configured to set parameters regarding a respective button. In this manner, the programmer may use a button command editor window to assign a command to each button 93-98 offered within a cell display.

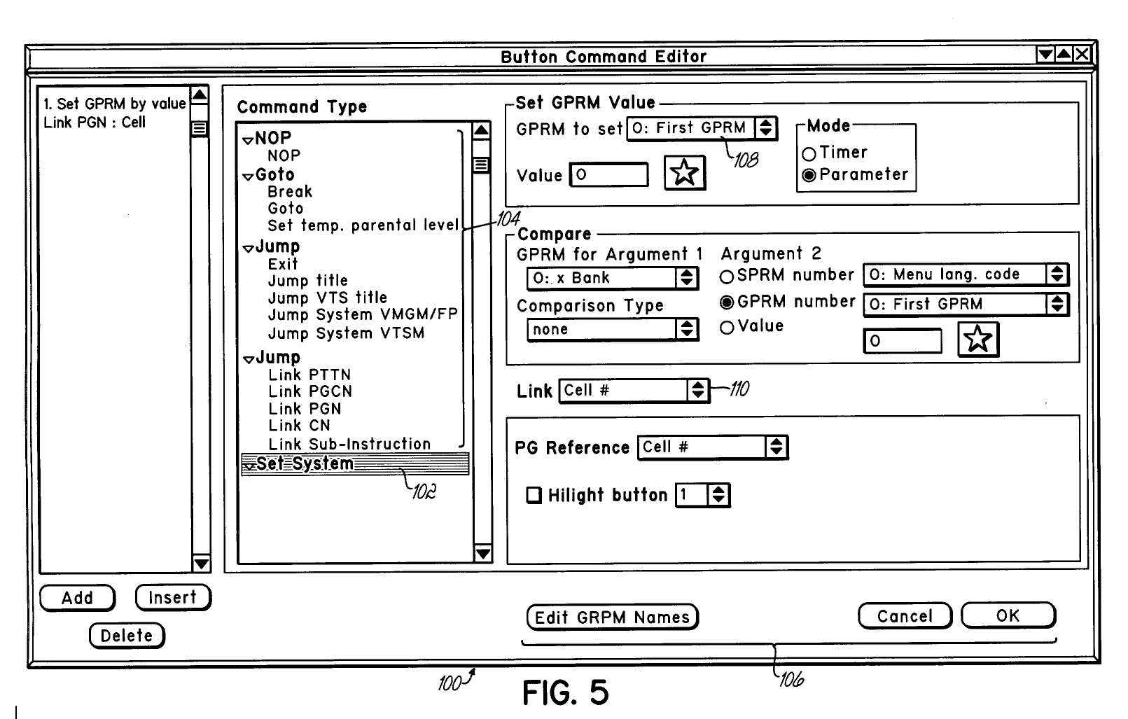

FIG. 5 is representative of one such button command editor window 100. As shown in FIG. 5, a programmer may click-on or otherwise select a single command 102 from among a complete list of commands displayed in a scroll-down list 104. The command 102 selected affects what information populates fields that are further descriptive of the command in area 106. In the instance of FIG. 5, the programmer has selected a SET SYSTEM command 102. Among other fields, selection of the SET SYSTEM command 102 initiates a display of fields in area 106 relating to GPRM and LINK preferences. As discussed briefly above, GPRM's (general parameters) typically record the operational history of user behavior. Sixteen GPRM's are available to programmers, each GPRM storing a number between 0 and 15. Values of GPRM's may be set/reset and otherwise adjusted throughout a program sequence.

In the exemplary button command editor window of FIG. 5, the GPRM field 108 is set to zero. Such a setting may be appropriate where a scoring protocol calls for a GPRM to increment only in response to an inappropriate answer. As such, the button command editor window 100 may correspond to a correct answer. Where another button command editor window is configured for an incorrect answer, one should appreciate that the GPRM field 108 could be accordingly set to an appropriate value. In addition to the GPRM field 108, the fields of area 106 also include a LINK field 110. The LINK field 110 functions to initiate execution of a cell (cell #) listed in the field 10. As shown in FIG. 5, the link may be selected from a pop-up list. Of note, the linked cell designated in the link field 110 is contained within the same PGC of the cell that displays the associated button, by virtue of the LINK command working exclusively as between cells 88-92 of a common PGC 80. As such, selection of the button 93 of FIG. 4 corresponding to the button command editor window 100 shown in FIG. 5 will result in the DVD player 14 displaying the cell linked in the window 100 without incrementing the GPRM.

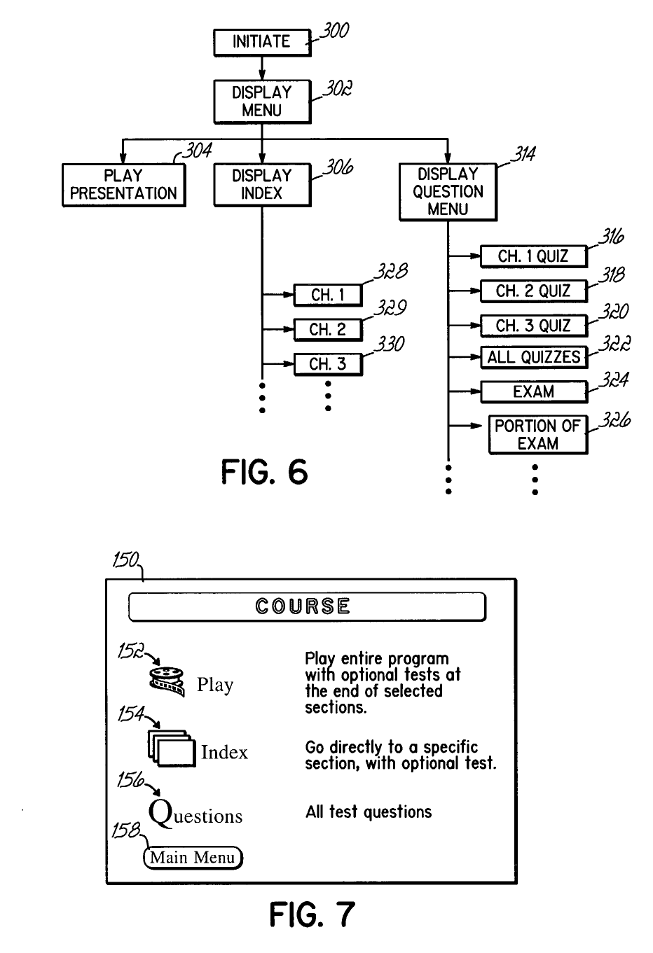

The logical program layout of FIG. 6 shows a display sequence of a DVD program that may be executed within the hardware environments of FIGS. 1 and 2. The sequence may comprise cells having MPEG stills or motion video backgrounds with buttons that allow a user to make decisions about playing back a DVD program. Suitable background images may include M2V, PICT or TIFF files. One such menu display 150 is shown in FIG. 7. Of note, certain exemplary steps of the flowchart of FIG. 6 may correlate with the user options presented in the display 150 of FIG. 7. Turning more particularly to block 300 of FIG. 6, a user may initialize DVD processes by pushing a power button and/or inserting the DVD disc 11 containing, for instance, pilot exam presentation software. A first play PGC may instruct the DVD player 14 what portion of the DVD disc 11 should play first. In the exemplary flowchart of FIG. 6, the DVD player 14 initializes a menu display at block 302 similar to that illustrated in FIG. 7.

The menu display 150 includes buttons 152-158 configured to present users with formatted data, additional menus and/or other playback options. A user may thus manipulate arrow keys on their remote control 21 to highlight and select buttons 152-158 of their choosing. For instance, selection of a first button 152 of the display 150 may initiate playback of an entire video instruction sequence at block 304 of FIG. 6. One skilled in the art should appreciate that audio and other features may accommodate MPEG video and converted graphics as desired. As such, the playback may be organized into chapters, each chapter being followed by optional quiz questions. In one embodiment, user responses to quiz questions are not scored or otherwise recorded.

Selection of an index button 154 of the display 150 at block 306 of FIG. 6 may cause the DVD player 14 to display a comprehensive listing of program topics 328-330 on the television screen of a user. Thus, a user may peruse all available topics 328-330 relating to all or a portion of a program course. As such, a separate button may accompany each displayed topic 328-330 for more focused selection. For instance, a user may desire to repeat a given lesson/chapter, or merely resume study/testing within a lesson at the same point where they previously left off. As such, a user may select the corresponding button linking to the appropriate PGC cell 80.

Where a user desires to answer test questions relating to the entirety of instructional material, they make select a menu button 156 labeled appropriately at block 314. In another embodiment, a command editor window for the selected button 156 may link to another cell display offering additional choices corresponding to different examination options 316-326. For instance, the user may select a button at block 316 initiating playback of a sequence of questions that follow presentation of a first chapter of instruction. Another selection may initiate presentation of an entire test at block 324. Still another option at block 326 may present a user with an option to take portions of available test questions. For instance, a menu button displayed in conjunction with block 326 may allow a user to test only those questions of an exam 324 relating to chapter three instructional materials. As such, respective navigational commands may point to cells having been linked to the chapter three question sequence of block 326.

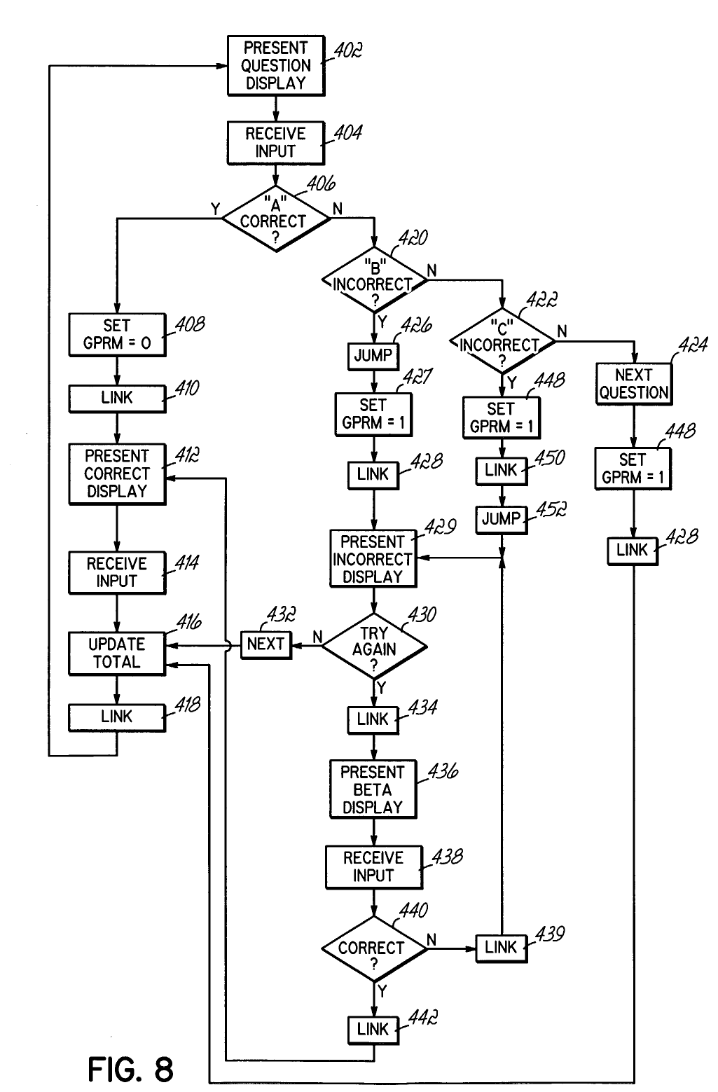

FIG. 8 shows a flowchart having process steps compatible with those of the logical program layout of FIG. 6, as well as within the hardware environments of FIGS. 1 and 2. The illustrative steps of FIG. 8 are configured, in one respect, to present two visually and audibly imperceptible displays having different underlying program content. As such, a scoring scheme of FIG. 8 includes a mechanism whereby a user may re-attempt a missed question without affecting the user's aggregate score for the test.

Turning more particularly to the flowchart at block 400, a user may access a question set via remote control keys and menu buttons. Selection of the appropriate menu button may initiate a display 87 of a question and potential answers. The exemplary display 87 of FIG. 4 shows one display suited for application within the flowchart of FIG. 8. As such, the display presented at block 402 of FIG. 8 prompts the user to highlight and choose a button 93-98 corresponding to a proffered answer. For purposes of the flowchart of FIG. 8, answer “A” of the display 87 of FIG. 4 is a correct answer, while answers “B” and “C” are incorrect. A “Next Question” button 98 selection may allow a user to skip to another question. While one skilled in the art should appreciate that any number of suitable scoring schemes may be accommodated by the underlying precepts of the principles of the present invention, the flowchart of FIG. 8 may realize a scoring protocol that initially assigns a point to a user's score in response to a missed question. Thus, selection of the “B.” “C,” or “Next Question” buttons 94, 96, 98, respectively, will increment an accumulating score of a user. The total score is then be translated into a percentage or other meaningful value at the conclusion of a testing session. Of note, the aggregate score may ignore re-attempts directed towards answering previously missed questions. As discussed herein, the visually identical/programmatically diverse display feature of the embodiment can enable such a scoring scheme within the DVD environment.

At block 404, the DVD receives input corresponding to a button 93-98 selected by the user. Of note, the display 87 of FIG. 4 may be “infinite,” in that it will remain displayed on the television of the user until a selection is made. Other embodiments may limit the amount of time a display 87 is presented to a user. As such, a user may only have a preset span of time within which to respond to a question or tasking prior to another screen display automatically appearing at the expiration of the preset increment. Thus, user input for purposes of an embodiment of the invention includes an election by the user not to answer within a preset increment. That is, user input may comprise user inaction under certain circumstances. In any case, selection of a button 93 corresponding to a correct answer at block 404 may cause the DVD player 14 to reference a button command editor window 100 similar to that of FIG. 5.

As per the properties of the button 93 selected at block 406, the DVD player 14 may execute a SET SYSTEM command at blocks 408 and 410. Namely, a first GPRM bank may be set to zero at block 408. The zero point setting of block 408 is appropriate in a scoring scheme where only wrong answers merit point assignments. Of note, the first GPRM bank may be used to keep a current scoring assignment for a presently attempted question. As discussed below in greater detail, a second GPRM bank may be used to compile an accumulating score that accounts for all original answer attempts. At block 410, the DVD player 14 may execute a navigational command suited to realize another, appropriate display. For instance, where the cell containing the next display is within the same PGC, the DVD player 14 may LINK to the cell at block 410.

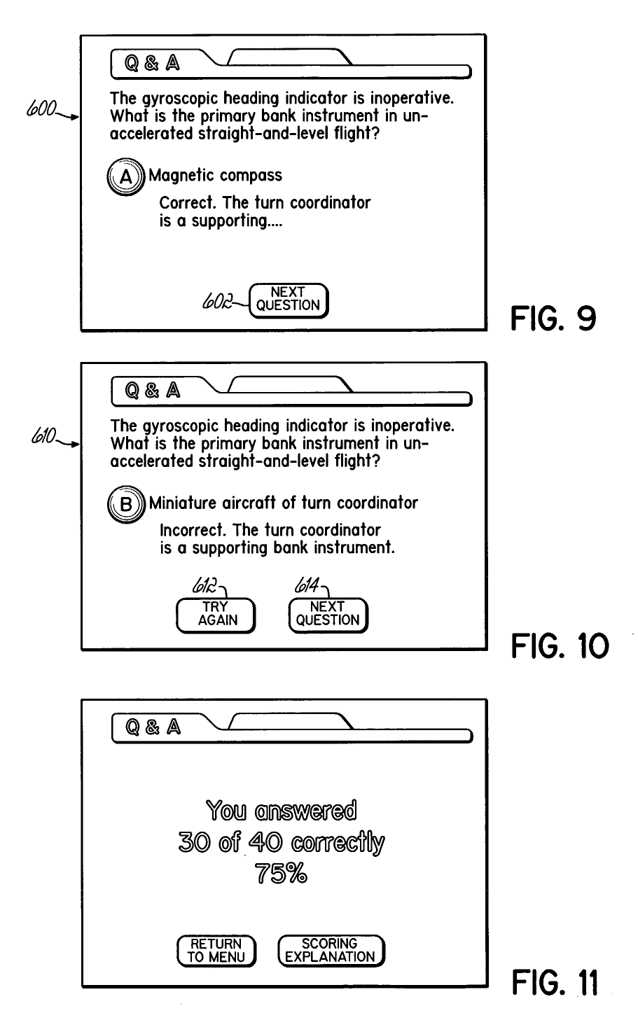

FIG. 9 shows an exemplary display 600 appropriate for presentation at a user's television set at block 412 of the flowchart of FIG. 8. As shown in FIG. 9, the display 600 includes a “Next Question” button 602, which the user may select at block 414. This button 602 may be programmatically configured via its own button command editor window to initiate a SET command at blocks 416 and 418. In part, the SET command may function to add the first, current GPRM bank to the second, accumulating GPRM bank at block 416. Assuming the stored score of the second GPRM to be zero at the onset of an examination session, the total score will be zero. This scoring process thus accommodates aspects of a scoring protocol where it is undesirable to accumulate points for correct answers.

Of note, while the two GPRM banks/values are added at block 416, one familiar with premastering processes should appreciate that other mathematical functions may be employed to manipulate the second GPRM with respect to the first, to include subtraction, division and multiplication. Additionally, one skilled the art should appreciate that multiple layers of GPRM's may be so manipulated with respect to each other while not offending the principles of the present invention. That is, embodiments of the invention are limited only by the number of GPRM's and mathematical functions available through a DVD programming interface.

As part of the SET command initiated in response to the input at block 414, the DVD player 14 may LINK to a next occurring question in a test sequence at block 418. Thus, the user may be presented with another question at block 402. While the total score tracked by the accumulating GPRM is not incremented as a result of the correct response of the user at block 406, one skilled in the art should readily appreciate that another application may call for a point(s) to be scored in response to correct answers, or a combination of correct and incorrect answers. Thus, embodiments of the invention may accommodate all manner of scoring scenarios, to include examinations and interactive games.

In the scoring embodiment discussed in the context of FIG. 8, should the user select an incorrect answer at either block 420 or 422, or alternatively select the “Next Question” button 98 at block 424, the total score of the accumulating GPRM is incremented at block 416. However, subsequent attempts to correctly answer the question will not further increment or otherwise affect the total score. For instance, the user may select at block 420 an incorrect answer corresponding to answer “B” of FIG. 4. The button (94 of FIG. 4) selection ultimately prompts presentation of an appropriate display at block 429. FIG. 10 shows one such display 610 suited for presentation to a user at block 429 of FIG. 8.

To this end, the DVD player 14 may execute another navigational command at block 426. Unlike the LINK command of block 410, however, this step may comprise a JUMP command. The need for a different command at block 426 may be attributable to a circumstance of the cell that contains the display of block 429 being in a different PGC. As discussed herein, a JUMP command is often required to bridge cells of different PGC's and/or domains. One of numerous reasons why a programmer might utilize multiple PGC's includes increased storage capacity (many programs are too large to be contained within a single PGC), as well as a more streamlined and categorical premastering architecture.

Thus, the button 94 selected by the user at block 420 may JUMP to a cell outside of the original PGC. That is, the command assigned to the button 94 via its command editor window consists of a JUMP. As the button 94 is programmatically limited to a single command, the button 94 is only operable to point to another cell. However, the scoring protocol of the embodiment may further require that the accumulating GPRM be incremented to account for the missed answer. As such, another command must be logically linked with the button 94 selected at block 420. In one embodiment, such an additional command may be realized through use of a dummy program chain. A dummy program chain may include a PGC having a pre-command(s) and/or post-command(s) configured to perform the additional function/command. As such, a dummy program chain may be useful in expanding the number of commands from 1 to 256 (128 pre-commands and 128 post-commands) that are available in response to a viewer activating a button. Of note, dummy program chains must contain at least a single frame video/MPEG image. However, a black frame may fulfill this requirement.

Thus, a dummy program chain of one embodiment may comprise a PGC having a black frame that is transparently displayed to the user at an instant subsequent to the pre-commands of the PGC executing a SET SYSTEM command. When the user selects the input correlated to the incorrect answer, the DVD player 14 executes a JUMP command to the dummy program chain at 426. The SET SYSTEM pre-command may set the value of the first GPRM to “one” in accordance with scoring protocol at block 427, and JUMP (with additional dummy program chains) or LINK, as appropriate, at block 428 to a cell containing the display of block 429. Thus, an embodiment of the present invention may utilize a dummy program chain to realize different scoring schemes and visual/audio effects.

The display at block 429 of FIG. 8 may present the user with additional navigation choices. As shown in the exemplary display 610 of FIG. 10, the user may attempt to answer the question correctly using button 612, or move on to the next question using button 614. The flowchart of FIG. 8 accounts for both these options respectively at blocks 430 and 432. As above, user selection of the “Next Question” button 614 at block 432 may result in a SET command executing, and the total GPRM incrementing at block 416. Conversely, selection of the “Try Again” button 612 at block 430 of FIG. 8 may result in navigation (LINK/JUMP at block 434) to a cell displaying a second, ‘Beta’ screen at block 436. Significantly, this second, Beta screen may appear visually identical to the first question screen 87 displayed at block 402 and shown in FIG. 4. However, the Beta screen is actually part of a different cell. As such, the user may be unaware that they are not actually viewing the original display 87. Yet despite its identical audio/visual display, the different cell may have different, underlying programming. An embodiment of the present invention capitalizes on the likeness of the Beta screen to create a perception in the user that the same buttons 93-98 of the original display 87 now have different functionality. That is, selecting button 93 (“A”) of the first display 87 may have different command consequences than will button “A” of the second, Beta screen, and so on. Of note, one embodiment may exclude answers previously attempted, and/or include hints on the Beta screen where desired.

In practice, the feature of the Beta screen enables a DVD player 14 to receive subsequent answer attempts by the user without further affecting the overall score stored at the accumulating GPRM. As such, the user may re-attempt another answer by selecting another answer button at block 438. If the selected button of the Beta display corresponds to a correct answer at block 440, the display may LINK or JUMP to a correct answer display at block 412. Notably, the value of the first GPRM (set to one) remains unaltered by selection of the correct answer at block 440. As discussed above in connection with the text describing blocks 412-418, the value of the first GPRM is added to the accumulating GPRM, and a next question is displayed. Thus, the total score of the user per the second GPRM reflects only that the question of block 402 was originally answered incorrectly at block 420.

Similarly, should the user unsuccessfully re-attempt the question at block 440 (choose answer “B” or “C”), their total score will remain unaffected. Namely, the current value of “one” assigned to the first GPRM table stands irrespective of the number and accuracy of subsequent attempts. To this end, the user may be presented with yet another opportunity to correctly answer the question back at block 430. At any time, the user may elect the “Next Question” button of the Beta display. As with a correct answer response at block 440, the “Next Question” selection at block 432 activates the processes of block 416. That is, the current value of the first GPRM is added to the total of the second GPRM. In this manner, the embodiment of FIG. 8 preserves a score indicative of the user's original attempt at the question as presented at block 402.

Beginning at block 422 of FIG. 8, another exemplary incorrect answer sequence is shown for button 96 (“C”) of FIG. 4. As with the above discussed answer sequence concerning wrong answer “B,” sequenced steps associated with incorrect answer “B” include use of a visually identical/programmatically diverse display at block 436. However, instead of using the dummy program chain feature associated with text describing a response to a “B” incorrect answer, the processes beginning at block 422 in response to a user selecting the “C” button utilize a post-command function configured to realize comparable command versatility. In any case, it should be appreciated that command mechanisms used to navigate between different cells may be diverse as allowed by DVD programming rules. Thus, any navigation command employed in the flowchart of FIG. 6 may be substituted with a LINK, JUMP (by itself or in combination with a dummy program chain), and/or a pre-/post-command platform command(s).

More particularly, user input designating button 96 (“C”) at block 422 may correlate to a button command editor window configured to execute a SET SYSTEM command. The command may include a function that sets the value of the first GPRM to one at block 448. Again, this setting accords with a scoring scheme consistent with an embodiment of the invention where every initial, incorrect response adds one point to a running total. Of note, it may be desirable to present an incorrect answer display to the user at block 429 in response to the incorrect answer. As above, the cell containing the display may be contained within a different PGC than that associated with the SET SYSTEM command. Thus, a JUMP command is required. Because the button 96 associated with the “C” answer already invokes the SET SYSTEM command, another mechanism must be employed to realize another command. While a dummy program chain operation, such as discussed above, may serve in such capacity under certain circumstances, an embodiment of the present invention may alternatively utilize post-commands.

As such, the SET SYSTEM command may further LINK to a cell near or at the end of the current PGC. For example, a button executing a SET SYSTEM command in cell 88 of FIG. 3 may link to cell 92 of the same PGC 80. Cell 92 may contain a black screen that the DVD player 14 displays for some minimum increment that is imperceptible to a viewer. The DVD player 14 then transitions to the postcommands 84 of the PGC 80 as per normal DVD operations. The first of such postcommand(s) 84 may comprise the JUMP command needed to arrive at the incorrect answer display at block 429. Thus, the user is unaware of the transparent transition from the display of block 406 to that of block 429. As with the dummy program chain feature, similar post-command operations using any DVD command type may be executed to realize additional versatility in accordance with embodiments of the invention.

From block 429, the user may elect to move on to the next question at block 432, or try the same question again at block 430. As discussed above, any reattempt of the question may be made on the Beta screen display of block 436. As such, the total score of the user remains unaffected by subsequent responses to the same question. Of note, upon the user answering the last question of a question series or session, the DVD player 14 may correlate the total score of the second, accumulating GPRM to an appropriate display using logic built into the DVD programming interface and known to one skill in the art of premastering. For instance, if the value of the second GPRM of a 14 question application is 10, then the DVD player 14 will navigate to a display reflecting the user's score as a percentile. Such an exemplary display is shown in FIG. 11.

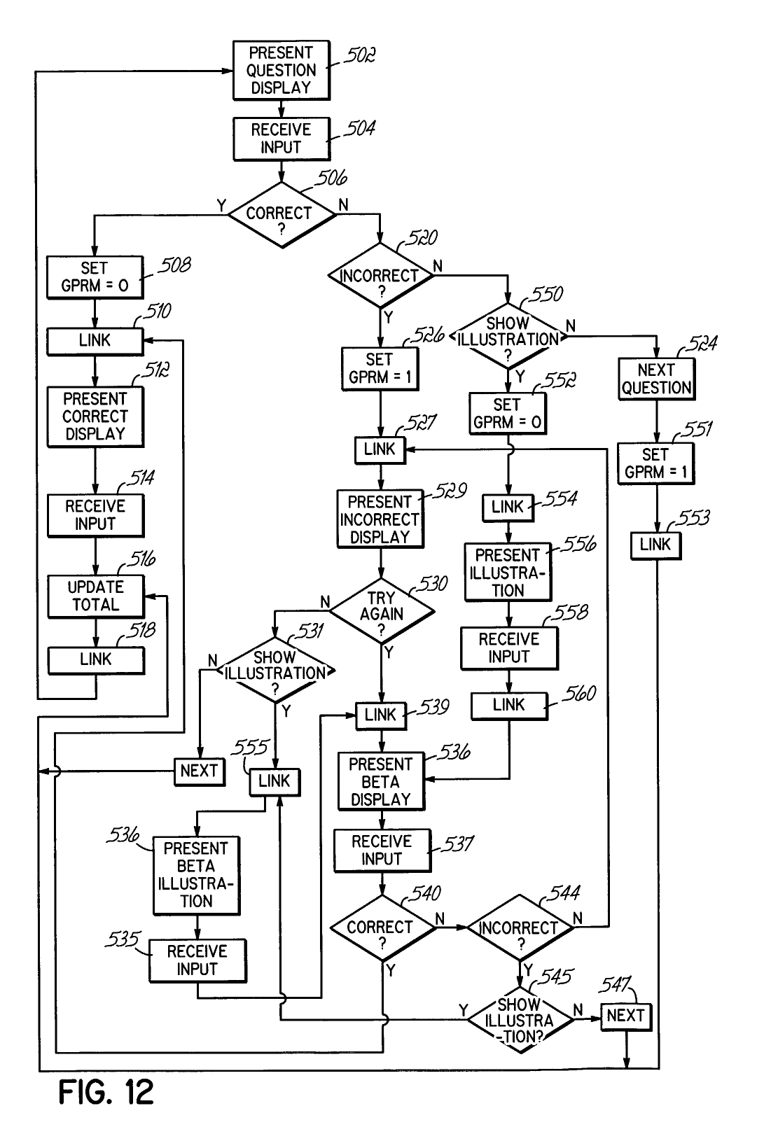

It should be appreciated that the sequenced steps of the flowchart of FIG. 8 are intended for enabling and best mode purposes only, and may be interchanged and augmented to realize other features while remaining within the scope of the present invention. For instance, the flowchart of FIG. 12 supplements the processes of FIG. 8 with illustrative materials useful in certain examination and entertainment contexts. The steps of FIG. 12 further expand the general concept of having two displays with identical visual content, but different underlying programming, by applying it in similar fashion to the illustrative displays.

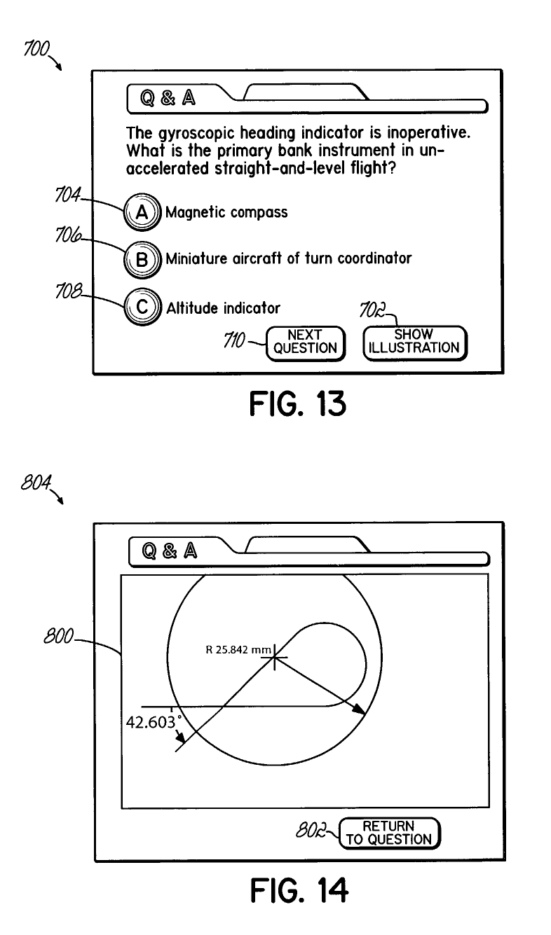

In general, the diagram of FIG. 12 flows in similar fashion to that of FIG. 8, except for incorporation of graphical display processes beginning at block 550. As such, a suitable display 700 at block 402 might include a “Show Illustration” button 702 as shown in the display of FIG. 13. The illustration may comprise a still frame, video and/or audio sequence useful in responding to the display 700 of block 402. In the context of a flight instruction examination, such an exemplary illustration may include a digital chart useful in navigation. Thus, a user may initially forego buttons/answer selections 704-710 corresponding to blocks 506 and 520, and instead initiate those processes beginning at block 550 that are configured to present the desired illustration.

More particularly, selection of the “Show Illustration” button 702 of FIG. 13 may initiate execution of a SET SYSTEM command at blocks 552 and 554 of FIG. 12. As such, the LINK command of block 554 may precede display of the exemplary image 800 of FIG. 14 as presented at block 556 of FIG. 12. As shown in FIG. 14, a user is prompted to select the “Return to Question” button 802, which corresponds to block 558 of the flowchart of FIG. 12. The button selection may cause the DVD player 14 at block 560 to navigate to the display of a Beta screen of the initial question at block 536. As with the Beta screen application disclosed in the text describing FIG. 8, the visually and audibly identical Beta screen of FIG. 12 gives the user the impression that they have actually returned to the original, Alpha, display of block 502.

The user may then select a response from among those selections of the Beta display at block 537. A correct response at block 540 may invoke a navigation command at block 510. The navigation command, which may comprise a LINK, JUMP, or combination of these and other commands, may lead ultimately to the display of a correct answer screen at block 512. Conversely, an incorrect response at block 544 may cause the DVD player 14 to execute a SET SYSTEM command at blocks 526 and 527 configured to increment the first GPRM, as well as display an incorrect answer screen at block 529.

Of note, one embodiment may allow a user to view the navigational display 804 of FIG. 14 at other instances besides that discussed in conjunction with block 556. For instance, an incorrect answer display of block 529 may include a “Show Illustration” button similar to that included in the display of FIG. 13. Selection of such a button at block 531 of FIG. 12 may LINK or otherwise navigate at block 555 to a second, or Beta, version of the image of FIG. 14 displayed at block 533. Input from the user at block 535 indicating a desire to return to the question may initiate navigation at block 539 suited to display the Beta question screen at block 536. As above, responses to the Beta screen display at blocks 540, 544 and 547, as with subsequent presentation of the Beta image display via block 533 will not affect the aggregate score of the user for evaluation purposes. Moreover, it should be appreciated that other suitable embodiments may rely on a single Beta image and link exclusively to it.

While the exemplary sequence of steps shown in FIG. 12, as with those of FIG. 8, may have particular utility in certain contexts, it should be understood that the order of such steps may be rearranged and/or modified to suit different system requirements. Likewise, while the present invention has been illustrated by a description of various embodiments and while these embodiments have been described in considerable detail, it is not the intention of the applicants to restrict or in any way limit the scope of the appended claims to such detail. For instance, “sensory impression” for purposes of this disclosure should be understood to apply generally to visual and/or audio content, and the “same,” or “indiscernible”, sensory impressions may vary in such characteristics as background, shape, color, font, border, arrangement and additional graphics/audio, among others, while remaining within the scope of the claims. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A method for navigating within a DVD program, comprising:
presenting to a user a first display of a plurality of displays contained within respective cells of a DVD program, the first display configured to create a sensory impression for the user and having an underlying program characteristic; and
subsequent to presenting the first display, presenting to the user a second display configured to create the same sensory impression for the user as the first display, the second display having a second underlying program characteristic.

2. The method according to claim 1, wherein configuring the second display to have the second underlying program characteristic further includes configuring the second underlying program characteristic to be programmatically distinct from the first underlying program characteristic.

3. The method according to claim 1, wherein configuring the second display to have the second underlying program characteristic further includes configuring the second underlying program characteristic to be identical to the first underlying program characteristic.

4. The method according to claim 1, further comprising configuring the first and second underlying program characteristics to include a command selected from a group consisting of: SET, SET SYSTEM, LINK and some combination thereof.

5. The method according to claim 1, further comprising using the first underlying program to initiate altering a value stored in a table, wherein the second underlying program characteristic is configured to preserve the value stored in the table.

6. The method according to claim 1, further comprising navigating between the first and second displays using a function selected from a group consisting of: a dummy program chain, a post-command, a pre-command, a LINK command, a JUMP command, a SET command, a SET SYSTEM command and some combination thereof.

7. A method of rating performance of a DVD participant, comprising:
receiving user input responsive to a first DVD display prompt;
storing a value in response to the user input;
receiving subsequent user input directed to an indiscernible second DVD display prompt, wherein a score derived at least in part from the stored value remains unaffected by the subsequent input directed to the second DVD display prompts; and
outputting the score.

8. The method according to claim 7, wherein storing the value in response to the user input further includes storing the value in a first GPRM.

9. The method according to claim 7, wherein storing the value in response to the user input further includes storing the value using a SET SYSTEM command.

10. The method according to claim 7, wherein receiving the user input and the subsequent user input further includes presenting to a user respective buttons configured to receive the user and subsequent user input.

11. The method according to claim 7, further comprising navigating between the first and second DVD display prompts using a function selected from a group consisting of: a dummy program chain, a post-command, a pre-command, a LINK command, a JUMP command, a SET command, a SET SYSTEM command and some combination thereof.

12. The method according to claim 7, wherein receiving subsequent user input further includes storing the score in a second GPRM.

13. The method according to claim 7, wherein receiving subsequent user input further includes mathematically modifying the score using the value.

14. The method according to claim 7, wherein receiving subsequent user input further includes using a SET command to modify the score using the value.

15. The method according to claim 7, further comprising correlating the score to a score display.

16. The method according to claim 15, further comprising presenting the score display to the user.

17. An apparatus, comprising:
a DVD player; and
program code incident on the DVD player, the program code configured to enable a user to navigate between a plurality of displays contained within respective cells of a DVD program, a first display of the plurality of displays programmatically configured to create a sensory impression for the user and having an underlying program characteristic; the program code being further configured to subsequently present to the user a second display of the plurality of displays configured to create a same sensory impression for the user, the second display having a second underlying program characteristic.

18. The apparatus according to claim 17, wherein the second underlying program characteristic is distinct from the first underlying program characteristic.

19. The apparatus according to claim 17, wherein the second underlying program characteristic is the same as the first underlying program characteristic.

20. The apparatus according to claim 17, wherein the underlying program characteristics includes a command selected from a group consisting of: SET, SET SYSTEM, LINK and some combination thereof.

21. The apparatus according to claim 17, wherein the underlying program characteristics include a cell button.

22. The apparatus according to claim 17, wherein the sensory impression includes video data.

23. The apparatus according to claim 17, wherein the sensory impression includes audio data.

24. The apparatus according to claim 17, wherein the first underlying program initiates altering a value stored in a table, wherein the second underlying program characteristic is configured to preserve the value stored in the table.

25. The apparatus according to claim 17, wherein the first and second displays reside within respective cells of the same program chain.

26. The apparatus according to claim 17, wherein the first and second displays reside within respective cells of distinct program chains.

27. The apparatus according to claim 17, wherein the program code enables a navigation between the first and second displays using a function selected from a group consisting of: a dummy program chain, a post-command, a pre-command, a LINK command, a JUMP command, a SET command, a SET SYSTEM command and some combination thereof.

28. An apparatus, comprising:
a DVD player; and
program code incident on the DVD player, the program code configured to receive user input responsive to a first DVD display prompt and store a value in response to the user input, wherein the program code is further configured to receive subsequent user input directed to an indiscernible DVD display prompt, wherein a score derived at least in part from the stored value remains unaffected by the subsequent input and the program code initiates outputting the score.

29. The apparatus according to claim 28, wherein the value is stored in a first GPRM.

30. The apparatus according to claim 28, wherein the score is stored in a second GPRM.

31. The apparatus according to claim 28, wherein the program code is configured to mathematically modify the score as a function of the value.

32. The apparatus according to claim 28, wherein the program code initiates presenting a splash display indicative of the appropriateness of the user input in response to the user input.

33. The apparatus according to claim 32, wherein the program code initiates presenting the splash display to the user.

34. The apparatus according to claim 28, wherein the first DVD prompt comprises a button.

35. The apparatus according to claim 28, wherein the first and indiscernible display prompts reside within respective cells of the same program chain.

36. The apparatus according to claim 28, wherein the first and indiscernible display prompts reside within respective cells of distinct program chains.

37. A program product, comprising:
program code incident on a DVD player, the program code configured to enable a user to navigate between a plurality of cells contained within respective cells of a DVD program, the first display programmatically configured to create a sensory impression for the user and having an underlying program characteristic; the program code being further configured to subsequently present to the user a second display programmatically configured to create an indiscernible sensory impression for the user, the second display having a second underlying program characteristic; and
a signal bearing medium bearing the program code.

38. The program product of claim 37, wherein the signal bearing medium includes at least one of a recordable medium and a transmission-type medium.

39. A program product, comprising:
program code incident on a DVD player, the program code configured to receive user input responsive to a first DVD display prompt and store a value in response to the user input, wherein the program code is further configured to receive subsequent user input directed to an indiscernible DVD display prompt, wherein a score derived at least in part from the stored value remains unaffected by the subsequent input and the program code initiates outputting the score; and
a signal bearing medium bearing the program code.

40. The program product of claim 39, wherein the signal bearing medium includes at least one of a recordable medium and a transmission-type medium.
